(19) United States
(12) Patent Application Publication
(10) Pub. No.: US 2025/0150332 A1
(43) Pub. Date: May 8, 2025

(54) METHODS AND APPARATUSES FOR COMMUNICATION BETWEEN A WIRELESS DEVICE AND A NETWORK NODE

(71) Applicant: Telefonaktiebolaget LM Ericsson (publ), Stockholm (SE)

(72) Inventors: Dhruvin PATEL, Aachen (DE); Luis Felipe DEL CARPIO VEGA, Espoo (FI); Alexey SHAPIN, Luleå (SE); Ajay KATTEPUR, Bangalore (IN); Rong DU, Bromma (SE)

(21) Appl. No.: 18/838,091

(22) PCT Filed: Feb. 14, 2022
(86) PCT No.: PCT/SE2022/050158

§ 371 Date: Aug. 13, 2024

(51) Int. Cl. H04L 41/0659; H04L 41/0668; H04L 41/0677

(52) U.S. Cl. CPC H04L 41/0661; H04L 41/0668; H04L 41/0677

(57) ABSTRACT

Embodiments of the present disclosure provide a method performed by a wireless device for handling communication with a network node. The wireless device is connected to an industrial device in an industrial environment and the wireless device is in communication with the network node using a communication circuitry. The communication circuitry includes a plurality of components interconnected for communicating with the network node. The method includes detecting occurrence of a failure event in the communication circuitry and identifying at least one component of the plurality of components causing the failure event. The method further includes determining at least one component from the plurality of components, to handle the communication with the network node and enabling the at least one component for the communication with the network node.

### TECHNICAL FIELD

The present disclosure relates generally to wireless communication. More particularly, it relates to methods, wireless device, network node, and computer program products for handling communication between wireless device and network node in an industrial environment.

### BACKGROUND

In an industrial environment, various industrial devices are interconnected with wireless device for the communication with a network node. The interconnection between industrial devices and wireless device makes transmission of data reliable through remote places in a wireless communication network. This evolution of wireless communication network led to need of improvement in the various capabilities of the wireless communication network. These capabilities include reliability, availability and robustness in an event of failure of communication.

In the industrial environment, failure of the communication of the data is an unexpected event which can have severe consequences to production. In these types of industrial environments, the implementation of resiliency through hi-availability and fault tolerance are required. The failure of the communication may occurs due to physical hardware and software failures in various components of a communication circuity used in the industrial environment.

Considering the hardware and the software failures at the wireless device, more than one wireless device can be used as an alternative for transmission of the data to ensure high resilience against such failures. However, radio resource control signalling is multiplied when more than one wireless device is used for the communication of data between the network node and the industrial device. This leads to inefficient utilisation of the control signalling between the network node and the wireless device.

### SUMMARY

Consequently, there is a need for an improved method and arrangement for handling communication between a wireless device, and a network node that alleviates at least some of the above cited problems.

It is therefore an object of the present disclosure to provide a method, a wireless device, a network node and a computer program product for handling communication between the wireless device and the network node to mitigate, alleviate, or eliminate all or at least some of the above-discussed drawbacks of presently known solutions.

This and other objects are achieved by means of the method, the wireless device, the network node, and the computer program product as defined in the appended claims. The term exemplary is in the present context to be understood as serving as an instance, example or illustration.

According to a first aspect of the present disclosure, a method performed by wireless device for handling communication with a network node is disclosed. The wireless device is connected to an industrial device in an industrial environment and the wireless device is in communication with the network node using a communication circuitry. The communication circuitry comprises a plurality of components interconnected for communicating with the network node. The method comprises detecting occurrence of a failure event in the communication circuitry and identifying at least one component of the plurality of components causing the failure event. The method further comprises determining at least one other component from the plurality of components, to handle the communication with the network node and enabling the at least one other component for the communication with the network node.

In some embodiments, the plurality of components comprises a first set of components and a second set of components.

In some embodiments, the first set components comprises base band, BB processing components.

In some embodiments, the second set of components comprises radio frequency, RF components.

In some embodiments, the step of determining at least one other component from the plurality of components, to handle the communication with the network node comprising identifying whether the failure has been occurred in any component from the first set of components or the second set of components. The method further comprises selecting said at least one other component from the first set of components when it is identified that the failure has been occurred in any of the components in the first set of components and selecting said at least one other component from the second set of components when it is identified that the failure has been occurred in any of the components in the second set of components.

In some embodiments, the method further comprises transmitting information to the network node when the failure has been occurred in any component in the plurality of components. The information comprises one or more of an indication to indicate the failure in any of components in the first set of components or the second set of components, a level of synchronicity among the first set of components, parameters associated with the second set of components, and an indication to indicate that the at least one other component has been enabled for the communication with the network node.

In some embodiments, the parameters associated with the second set of components comprises one or more of information related to one or more antennas, position information of the one or more antennas, and delay information associated with feeders of the one or more antennas.

According to a second aspect of the present disclosure, a method performed by a network node for handling communication with the wireless device is disclosed. The wireless device is connected to an industrial device in an industrial environment and the network node is in communication with the wireless device through at least one component of a communication circuitry. The communication circuitry comprising a plurality of components interconnected for communicating with the network node. The method comprises receiving, from the wireless device, information comprising an indication indicating at least one other component from the plurality of components being enabled for communicating with the wireless device and controlling the communication with the wireless device in accordance with the information indicating at least one other component enabled for communicating with the wireless device.

In some embodiments, the information further comprising one or more of a level of synchronicity between each component among a first set of components of the plurality of components, and parameters associated with a second set of components of the plurality of components.

In some embodiments, the parameters associated with the second set of components comprise one or more of information related to one or more antennas, position information of the one or more antennas, and delay information associated with feeders of the one or more antennas.

In some embodiments, the step of controlling the communication with the wireless device comprises controlling one or more control parameters related to the communication with the wireless device in accordance with the received information from the wireless device.

In some embodiments, the one or more control parameters comprises information related to one or more of states of one or more control loops associated with the communication, status of Hybrid Automatic Repeat Request, HARQ process, channel between the wireless device and the network node, interference in the channel, beamforming measurements, rank and precoding for Multiple-Input Multiple-Output, MIMO and/or multiple transmission and reception points, Multi-TRP operation, power control, and inner loop and outer loop link adaptation.

In some embodiments, the step of controlling the communication with the wireless device further comprises detecting occurrence of a failure event at the network node. The method further comprises determining at least one other network node for handling the communication with the wireless device, and transmitting at least one context parameter to at least one other network node for handling the communication with the wireless device.

In some embodiments, the first set of components comprises a plurality of baseband, BB processing components and the second set of components comprises a plurality of radio frequency, RF components.

According to a third aspect of the present disclosure, an apparatus of the wireless device for handling communication with the network node. The wireless device is connected to an industrial device in an industrial environment and the wireless device is in communication with the network node using a communication circuitry. The communication circuitry comprises a plurality of components interconnected for communicating with the network node. The controlling circuitry is configured to perform detection of occurrence of a failure event in the communication circuitry and Identification of at least one component of the plurality of components causing the failure event. The controlling circuitry is further configured to perform determination of at least one other component from the plurality of components, to handle the communication with the network node and enabling of the at least one other component for the communication with the network node. A fourth aspect is a wireless device comprising the apparatus of the third aspect.

According to a fifth aspect of the present disclosure, an apparatus of the network node for handling communication with the wireless device. The wireless device is connected to an industrial device in an industrial environment and the network node is in communication with the wireless device through at least one component of a communication circuitry. The communication circuitry comprises a plurality of components interconnected for communicating with the network node. The controlling circuitry is configured to perform reception of information from the wireless device. The information comprises an indication indicating at least one other component from the plurality of components being enabled for communicating with the wireless device. The controlling circuitry is further configured to perform controlling of the communication with the wireless device in accordance with the information indicating at least one other component enabled for communicating with the wireless device.

A sixth aspect is a network node comprising the apparatus of the fifth aspect.

According to a seventh aspect of the present disclosure, there is provided a computer program product comprising a non-transitory computer readable medium, having thereon a computer program comprising program instructions. The computer program is loadable into a processor and configured to perform execution of the method according to the first and second aspects when the computer program is run by the processor.

In some embodiments, any of the above aspects may additionally have features identical with or corresponding to any of the various features as explained above for any of the other aspects.

An advantage of some embodiments is that alternative and/or improved approaches are provided for handling communication between the wireless device and network node in an industrial environment.

An advantage of some embodiments is that the physical hardware and software failures are handled efficiently.

An advantage of some embodiments is that availability and the high resilience against the hardware and the software failures are ensured, thereby to achieve ultra-reliable communication between the wireless device and the network node.

An advantage of some embodiments is that a control signalling between the network node and the wireless device is utilized effectively.

An advantage of some embodiments is the failure event is efficiently handled to ensure the robustness of communication system.

An advantage of some embodiments is that in the communication between the wireless device and network node is continued even in case of occurrence of the failure event.

An advantage of some embodiments is that the improvement in performance shall preferably be made to utilize the radio resources used for control signalling between the network node and the wireless device.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 discloses an example of an industrial environment according to some embodiments;

FIGS. 2A-2C illustrate example scenarios for handling of communication between wireless device and network node during occurrence of failure event;

FIG. 3 is a flowchart illustrating example method steps according to some embodiments;

FIG. 4 is a flowchart illustrating example method steps according to some embodiments;

FIG. 5 is a schematic block diagram illustrating an example apparatus according to some embodiments;

FIG. 6 is a schematic block diagram illustrating an example apparatus according to some embodiments; and

FIG. 7 discloses an example computing environment according to some embodiments.

### DETAILED DESCRIPTION

Aspects of the present disclosure will be described more fully hereinafter with reference to the accompanying drawings. The apparatus and methods disclosed herein can, however, be realized in many different forms and should not be construed as being limited to the aspects set forth herein. Like numbers in the drawings refer to like elements throughout.

The terminology used herein is for the purpose of describing particular aspects of the disclosure only and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

In the present disclosure, wireless device also known as mobile terminals and/or wireless terminals, are enabled to communicate wirelessly with a network node in a wireless communication network.

Typically, a network node serves or covers one or several cells of the wireless communication network. That is, the network node provides radio coverage in the cell(s) and communicates over an air interface with the wireless device(s) operating on radio frequencies within its range. The network node may be also referred to as “eNB”, “eNodeB”, “NodeB” or “gNB”, depending on the technology and terminology used. In the present disclosure, the network node device may also be referred to as a base station, BS.

In the present disclosure, it is assumed that connection establishment has already been completed between the wireless device and the network node.

In the following description of exemplary embodiments, the same reference numerals denote the same or similar components.

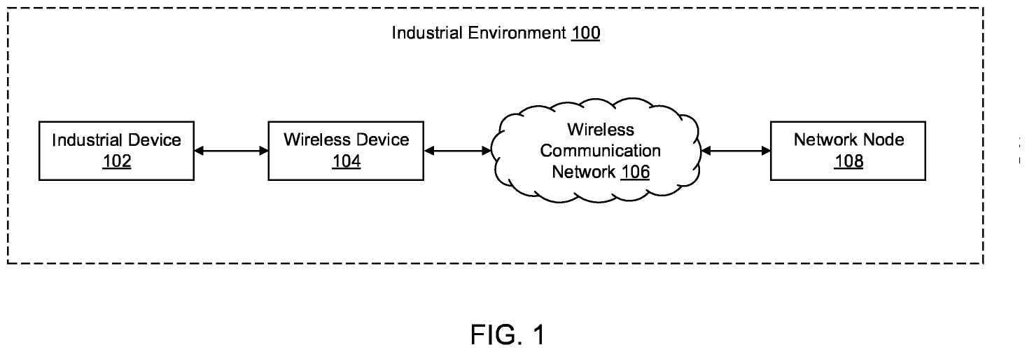

FIG. 1 discloses an industrial environment 100. Some of the examples of the industry environment 100 may include a factory, a manufacturing unit, guided robotic environment, etc. The industrial environment 100 comprises an industrial device 102, wireless device, 104, a wireless communication network 106, and a network node 108. Examples of the industrial devices 102 may comprise Articulated Robots, Cartesian Robots, Selective Compliance Assembly Robot Arm, Delta robots, Polar robots, a 6-DOF robotic arm, collaborating robotic arms, Automated Guided Vehicles, AGVs, with omni-wheels, other robotic devices, automotive machines solar and wind power devices, or industrial sensors.

The industrial device 102 communicates with the network node 108 through the wireless device 104 in the wireless communication network 106. For downlink transmission, the wireless device 104 is configured to receive control signals intended for controlling the industrial device 102 from the network node 108 and transmit the control signals to the industrial device 102. For uplink transmission, the wireless device 104 is configured to receive a signal from the industrial device 102 and transmit the received signal to the network node 108 through the wireless communication network 106.

The network node 108 is generally a fixed station that communicates with the wireless devices and may also be referred to as new radio, NR, base station i.e., a gNB or a Node B, an evolved Node B (eNode B), an access point, etc. For example, the network node 108 may be a radio access network comprising a plurality of base stations or evolved node base stations (not shown) or the internet using one or more suitable communication protocols for managing radio resource control signalling by transmission of command messages or control signals to the wireless device 104.

The wireless device 104 may be stationary or mobile and may also be referred to as a remote station, a mobile station, mobile equipment, a terminal, a remote terminal, an access terminal, a station, etc. The wireless device may be a cellular phone, a personal digital assistant (PDA), a wireless modem, a wireless communication device, a handheld device, a subscriber unit, a laptop computer, etc.

It should be noted that the industrial environment 100 is not limited to above-mentioned components, other components can also be present in the industrial environment 100 other than the component shown in the FIG. 1.

The wireless device 104 is in communication with the network node 108. Such communication between the network node 108 and the wireless device 104 requires that the connection between the wireless device 104 and the network node 108 remain intact. This communication is enabled by components of wireless device 104 and the network node 108.

However, there can be physical hardware and software failures in the components of wireless device 104 and network node 108 which may lead to the failure of communication between the network node 108 and the wireless device 104.

Therefore, according to some embodiments of the present disclosure, the wireless device 104 implements a method for handling communication with the network node 108. According to some embodiments of the present disclosure, a network node 108 implements a method for handling communication with the wireless device 104 in the industrial environment 100. The wireless device is connected to an industrial device in the industrial environment 100 and the wireless device 104 is in communication with the network node 108 using a communication circuitry. The communication circuitry comprising a plurality of components interconnected for communicating with the network node 108.

According to some embodiments of the present disclosure, the wireless device 104 detects occurrence of a failure event in the communication circuitry. For example, the wireless device 104 detects an interruption in the communication between the wireless device 104 and the network node 108. The failure event may be caused by a set of components or a second set of components of the communication circuitry. Further, the wireless device 104 identifies at least one component of the plurality of components causing the failure event. For example, the wireless device 104 determines whether the failure has been occurred in at least one component among the first set of components or the failure has been occurred in at least one component among the second set of components.

The wireless device 104 determines at least one other component from the plurality of components, to handle the communication with the network node 108. For example, the wireless device 104 determines the at least one other component from the set of components having the at least one component which causes the failure event. Further, the wireless device 104 enables the at least one other component for the communication with the network node 108.

According to some embodiments of the present disclosure, the network node 108 receives, from the wireless device 104, information comprising an indication indicating at least one other component from the plurality of components being enabled for communicating with the wireless device 104. For example, the indication indicates that the wireless device 104 has enabled other component in place of the failed component for the communication with the network node 108. Further, the network node 108 controls the communication with the wireless device 104. For example, the network node 108 communicates with the wireless device 104 through the other component enabled by the wireless device 104.

In case of the failure event caused by one of the component from the first set of components or the second set of components of the communication circuitry, the wireless device 104 identifies the other component from same set of components of wireless device 104 to handle the communication with the network node 108 and enables the identified other component for the communication with the network node 108. Therefore, the communication between the wireless device 104 and the network node 104 is not interrupted due to failure caused by the component of the wireless device 104. Thereby, the embodiments herein provides an improved method for handling communication between the wireless device 104 and the network node 108 in the industrial environment 100.

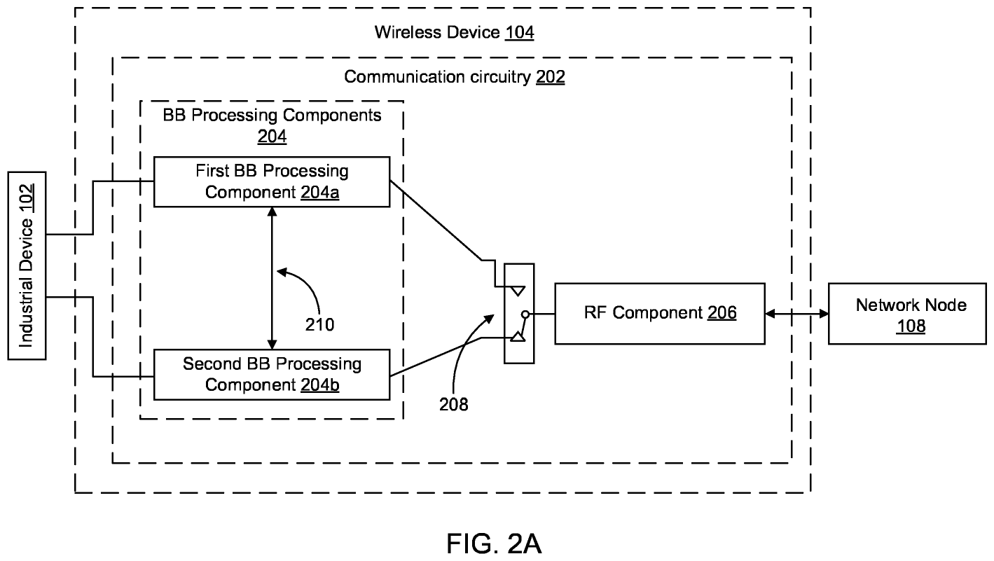

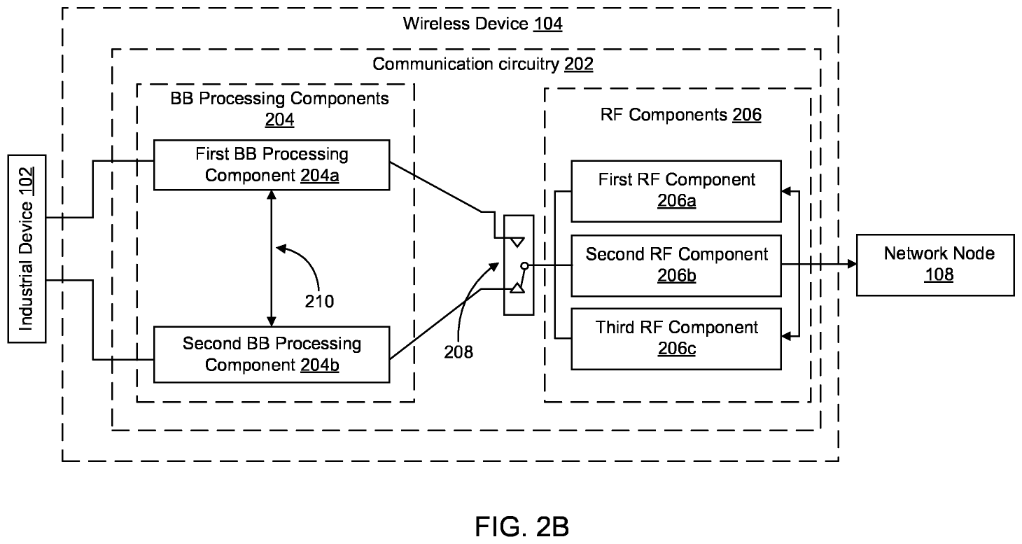

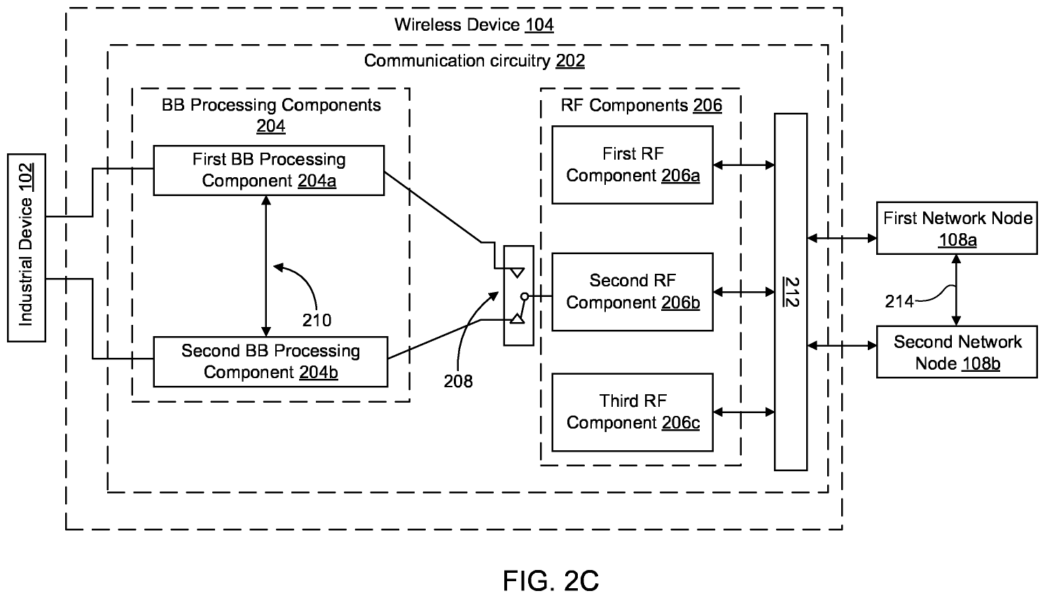

FIGS. 2A-2C are embodiments illustrating examples for handling communication between the wireless device 104 and the network node 108 in an industrial environment. As depicted in FIG. 2A-2C, the industrial device 102 communicates with the network node 108 through the wireless device 104. The communication between the wireless device 104 and the network node 108 is enabled by a communication circuitry 202 of the wireless device 104. The communication circuitry 202 includes one or more components responsible for the communication with the network node 108. For example, the communication circuitry 202 includes a set of baseband, BB processing components 204 and a set of radio frequency, RF components 206. The set of BB processing components 204 and the set of RF components 206 are interconnected to each other through a switch 208.

For downlink transmission, the RF component 206 receives RF signal from the network node 108 through an antenna (not illustrated). The RF component 206 filters the RF signal and converts the filtered RF signal into the digital signal. Further, the RF component 206 transmits the digital signal to the BB processing component 204 through the switch 208. The BB processing component 204 is adapted to convert the digital signal received from the RF component 206 to analog signal and transmit the analog signal to the industrial device 102.

For uplink transmission, the BB processing component 204 is adapted to convert analog signal received from the industrial device 102 to digital signal. For example, the BB processing component 204 generates a baseband signal corresponding to the data to be transmitted to the network node 108. The baseband signal is generated by using a signal generator, Analog to Digital, A/D convertors, or the like. Further, the BB processing component 204 outputs the baseband signal to the RF component 206 through the switch 208. The RF component 206 receives the baseband signal from the BB processing component 204 and up-converts the baseband frequency of the baseband signal to the radio frequency. For example, the RF component 206 converts the baseband signal into the RF signal using one or more processing circuitry. Examples of the processing circuitry includes RF modulator, filters, or the like. Further, the RF component 206 transmits the RF signal to the network node 108 using the antenna.

In first embodiment, multiple BB processing components are interconnected to a single RF component as illustrated in FIG. 2A. The set of BB processing components 204 comprises a first BB processing component 204a and a second BB processing component 204b. The set of BB processing components 204 may include more BB processing components (although not illustrated in FIG. 2A). The first BB processing component 204a and the second BB processing component 204b are interconnected with a RF component 206 through the switch 208. The switch 208 is configured to interconnect the set of BB processing components 204 with the RF component 206.

Assuming that the communication with the network node 108 is performed through the first BB processing component 204a and the RF component 206, for example, the first BB processing component 204a is interconnected to the RF component 206 for the communication with the network node 108. The wireless device 104 detects occurrence of a failure event in the communication circuitry 202 while the wireless device 104 is in communication with the network node 108. For example, the wireless device 104 detects that the communication with the network node 108 is interrupted due to failure in the first BB processing component 204a. Further, the wireless device 104 identifies at least one component in the communication circuitry 202 causing the failure event. For example, the wireless device identifies the second BB processing component 204b for the communication with the network node 108.

For example, the wireless device 104 determines the second BB processing component 204b to handle the failure event and enables the second BB processing component 204b for the communication with the network node 108. For example, the wireless device 104 switches the connection from the first BB processing component 204a to the second BB processing component 204b. The second BB processing component 204b is interconnected with the RF component 206 through the switch 208 to handle the communication with the network node 108 (as depicted in FIG. 2A.

In an embodiment, the wireless device 104 enables the second BB processing component 204b for the communication with the network node 108 without notifying the network node 108. In another embodiment, the wireless device 104 transmits an indication to the network node 108 indicating that the second BB processing component 204b has been enabled for the communication with the network node 108. The indication is transmitted to the network node 108 using control signaling. For example, the control signaling may include Media Access Control, MAC, control element transmission via Physical Uplink Shared Channel, PUSCH. Further, the wireless device 104 continues the communication with the network node 108 through the second BB processing component 204b.

In some embodiments, multiple BB processing components (e.g. the first BB processing component 204a and the second BB processing component 204b) are in operation simultaneously for the communication with the network node 108. However, the output of one of the BB processing components is allowed to be transmitted to the RF component 206 while output from other BB processing components are discarded. For example, the output of the first BB processing component 204a is allowed to be transmitted to the RF component 206 while the output from the second BB processing component 204b is discarded when the first BB processing component 204a and the second BB processing component 204b are in operation simultaneously. In case the failure event is detected in one BB processing component (e.g. the first BB processing component 204a), output from other BB processing component (e.g. the second BB processing component 204b) is allowed to be outputted to the RF component 206.

In some embodiments, the wireless device 104 compares the output from the multiple BB processing components (e.g. the first BB processing component 204a and the second BB processing component 204b) using a pre-defined criteria. The wireless device 104 selects an output from one of the BB processing components (e.g. the first BB processing component 204a) to be transmitted to the RF component 206 based on the comparison.

Further, each BB processing component among the set of BB processing components (e.g. the first BB processing component 204a and the second BB processing component 204b) are interconnected with each other using an interface 210. For example, the first BB processing component 204a is configured to exchange at least one parameter with the second BB processing component 204b using the interface 210 to maintain synchronicity among the set of BB processing components 204. Further, the wireless device 104 transmits information indicating a level of synchronicity among the set of BB processing components 204 to the network node 108. For example, the level of synchronicity defines a degree with which the first BB processing component 204a is synchronous with the second BB processing component 204b.

The network node 108 receives the indication indicating that the second BB processing component 204b has been enabled for the communication with the network node 108. The network node 108 further receives the information indicating the level of synchronicity among the set of BB processing components 204. Further, the network node 108 controls the communication with the wireless device 104 in accordance with the level of synchronicity. For example, the network node 108 resets the states of one or more control loops associated with the communication between the wireless device 104 and the network node 108. Further, the network node 108 updates Hybrid Automatic Repeat Request, HARQ, process status and the power control loop associated with the communication between the wireless device 104 and the network node 108.

Therefore, in the first embodiment as described above with reference to FIG. 2A, the wireless device 104 determines the second BB processing component 204b of the communication circuitry 202 and enables the second BB processing component 204b for the communication with the network node 108. Therefore, the communication between the wireless device 104 and the network node 108 is not interrupted.

In second embodiment, the set of BB processing components are interconnected to a set of RF components as illustrated in FIG. 2B. The set of BB processing components comprises one or more of the first BB processing component 204a and the second BB processing component 204b. The set of BB processing components 204 may include more BB processing component (not illustrated). The set of RF components comprises one or more of the first RF component 206a, the second RF component 206b, and the third RF component 206c. The set of RF components 206 may include more RF components (not illustrated). The set of BB processing components 204 are interconnected with set of RF components 206 through the switch 208.

Assuming that the communication with the network node 108 is performed through the first BB processing component 204a and the first RF component 206a, for example, the first BB processing component 204a is interconnected to the first RF component 206a through the switch 208 for the communication with the network node 108. Alternatively, the communication with the network node 108 is performed through the second BB processing component 204a and the first RF component 206a. Alternatively, multiple BB processing components can be connected to single RF component at one time.

Further, the wireless device 104 detects occurrence of a failure event in the communication circuitry 202 while the wireless device 104 is in communication with the network node 108. For example, the wireless device 104 detects that the communication with the network node 108 is interrupted due to failure in a component of the communication circuitry 202 of the wireless device 104. Further, the wireless device 104 identifies at least one component in the communication circuitry 202 causing the failure event.

In this embodiment, the wireless device 104 identifies that the failure event has been occurred due to an RF component in the set of RF components 206. For example, the wireless device 104 identifies that the first RF component 206a causes the failure event. Further, the wireless device 104 determines at least one other component from the set of RF components 206 to handle the failure event. For example, the wireless device 104 determines the second RF component 206b to handle the communication with the network node 108 and enables the second RF component 206b for the communication. For example, the wireless device 104 switches the connection from the first RF component 206a to the second RF component 206b. The second RF component 206b is interconnected with any component of the set of BB processing components 206 to handle the communication with the network node 108.

In an embodiment, the wireless device 104 enables the second RF component 206b for the communication with the network node 108 without notifying the network node 108. In another embodiment, the wireless device 104 transmits an indication to the network node 108 indicating that the second RF component 206b has been enabled for the communication with the network node 108. Further, the wireless device 104 continues the communication with the network node 108 through the second RF component 206b.

The network node 108 receives the indication indicating that the second RF component 206b has been enabled for the communication with the network node 108. The network node 108 further receives the information comprising parameters associated with the RF components 206. Further, the network node 108 controls the communication with the wireless device 104 in accordance with the parameters associated with the RF components 206. For example, the network node 108 update the states and loops associated with the communication. Further, the network node 108 updates channel/interference information, timing advance, beamforming measurements, rank and precoding for Multiple-Input Multiple-Output, MIMO, and/or multiple transmission and reception points, Multi-TRP, operation, power control, inner loop and outer loop link adaptation associated with the communication. Alternatively, the network node 108 stores information of mapping between each RF component and each BB processing component.

Therefore, in the second embodiment as described above with reference to FIG. 2B, the wireless device 104 determines the second RF component 206b and enables the second RF component 206b for the communication with the network node 108. Therefore, the communication between the wireless device 104 and the network node 108 is not interrupted.

In third embodiment, the set of BB processing components 204 of the wireless device 104 is connected to through the set of RF components 206 and the set of RF components 206 are connected to different network nodes 108 as illustrated in FIG. 2C. The set of BB processing components 204 comprises one or more of the first BB processing component 204a and the second BB processing component 204b. The set of BB processing components 204 may include more BB processing components (not illustrated). The set of RF components 206 comprises one or more of the first RF component 206a, the second RF component 206b, and the third RF component 206c. The set of RF components 206 may include more RF components (not illustrated). The set of BB processing components 204 are interconnected with set of RF components 206 through the switch 208. The wireless device 104 is being connected to the first network node 108a and the second network node 108b. Alternatively, the wireless device 104 is being connected to more network nodes (not illustrated). The set of RF components 206 makes a parallel redundant connection 212 with the first network node 108a and the second network node 108b.

Therefore, in the third embodiment as described above with reference to FIG. 2C, two BB processing components are active at a time and are in communication with two different network nodes. For example, the first BB processing component 204a is in communication with the first network node 108a through the first RF component 206a. Also, the second BB processing component 204b is in communication with the second network node 108b through the second RF component 206b.

Each network node (e.g. the first network node 108a and the second network node 108b) are able to exchange the information with each other using an interface 214. For example the interface 214 is an X2 interface. The network node 108 tracks the mapping of the BB processing components 204 with the RF components 206 using the interface 214. In one example, the mapping includes the connection between the first BB processing component 204a and the first RF component 206a. In another example, the mapping includes the connection between the second BB processing component 204b and the second RF component 206b.

Further, the first network node 108a detects occurrence of a failure event in the first network node 108a. For example, the first network node 108a detects that the communication with the wireless device 104 is interrupted due to failure in the first network node 108a. The first network node 108a determines at least one other network node (e.g. the second network node 108b) for handling the communication with the wireless device 104. Further, the first network node 108a transmits at least one context parameter to the second network node 108b. For example, the at least one context parameter is transmitted through the X2 interface. Thus, the second network node 108b can maintain the communication with the wireless device 104 without interruption in the communication with the wireless device 104.

Therefore, in the third embodiment as described above with reference to FIG. 2C, two communications are active at same time, where wireless device 104 is in communication with two different network nodes. This ensures the availability of the second network node 108b to maintain the communication with the wireless device 104 against the failure of the first network node 108a. Therefore, the communication between the wireless device 104 and the network node 108 is not interrupted.

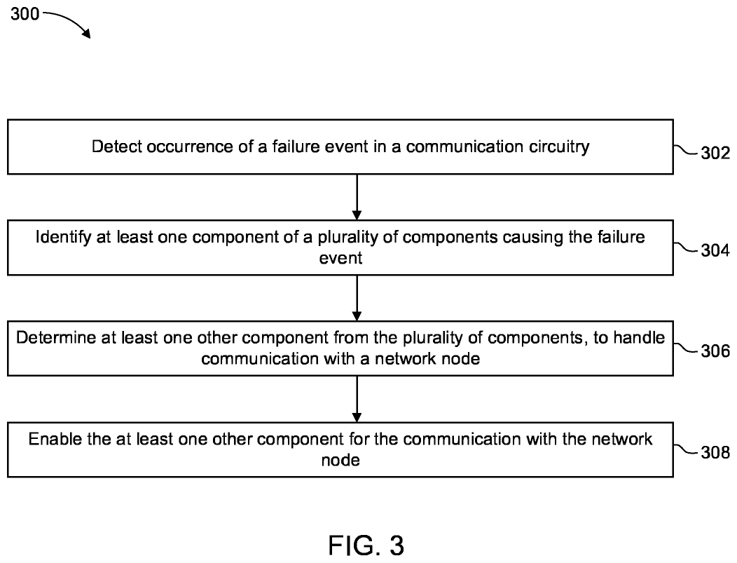

FIG. 3 is a flowchart illustrating example method steps of a method 300 performed by a wireless device for handling communication with a network node. The wireless device is connected to an industrial device in an industrial environment and the wireless device is in communication with the network node using a communication circuitry. The communication circuitry comprises a plurality of components interconnected for communicating with the network node.

At step 302, the method 300 comprises detecting occurrence of a failure event in the communication circuitry. For example, the wireless device detects that the failure event has been occurred in any of the plurality of components of the communication circuitry. The plurality of components comprises a first set of components and a second set of components. The first set of components comprises a plurality of BB processing components and the second set of components comprises a plurality of the RF components. The wireless device detects an interruption in communication with the network node due to the failure event occurred in any component of the communication circuitry of the wireless device.

At step 304, the method 300 comprises identifying at least one component of the plurality of components causing the failure event. The wireless device identifies at least one component from the plurality of BB processing components or the plurality of RF components. For example, the wireless device determines whether the failure has been occurred in a first BB processing component among the plurality of BB processing components or whether the failure has been occurred in a first RF component among the plurality of RF components.

At step 306, the method 300 comprises determining at least one other component from the plurality of components, to handle the communication with the network node. The wireless device determines at least one other component from the same set of components which includes the at least one component causing the failure event. For example, the wireless device identifies whether the failure has been occurred in any component from the first set of components or the second set of components. When it is identified that the failure has been occurred in any of the components in the first set of components, the wireless device selects at least one other component from the first set of components. When it is identified that the failure has been occurred in any of the components in the second set of components, the wireless device selects at least one other component from the second set of components. For example, when the at least one component causing the failure event belongs to the set of BB processing components then the wireless device determines the at least one other BB processing component from the set of BB processing components and when the at least one component causing the failure event belongs to the set of RF components then the wireless device determines the at least one other RF component from the set of RF components.

At step 308, the method 300 comprises enabling the at least one other component for the communication with the network node. For example, the wireless device switches the connection from the at least one component causing the failure event to at least one other component in same set of components. Further, the wireless device interconnects the at least one other component with one or more components belonging to the first set of components or the second set of components to handle the communication. For example, when another BB processing component is enabled for the communication with the network node then enabled BB processing component may be interconnected with the corresponding RF component which is active for the communication with the network node.

In an embodiment, the wireless device enables the at least one other component for the communication with the network node without notifying the network node. In another embodiment, the wireless device transmits an indication to the network node indicating that the at least one other component has been enabled for the communication with the network node.

Further, the wireless device transmits information indicating a level of synchronicity among the plurality of BB processing components to the network node when it is determined that the failure has been occurred in at least one BB processing component. As depicted in FIG. 2A, when the first BB processing component 204a causes the failure event, the wireless device enables the second BB processing component 204b and transmits the level of synchronicity among the BB processing components 204 to the network node.

The plurality of BB processing components are interconnected with each other through the interface. Each of the plurality of BB processing components has at least one parameter. The at least one parameter is exchanged among the plurality of BB processing components using the interface.

Further, the wireless device transmits information comprising parameters associated with the plurality of RF components to the network node when it is determined that the failure has been occurred in at least one RF component. The parameters associated with the plurality of RF components comprises one or more of information related to one or more antennas, position information of the one or more antennas, and delay information associated with feeders of the one or more antennas. As depicted in FIG. 2B, when the first RF component 206a causes the failure event, the wireless device enables the second RF component 206b and transmits the information associated with the RF components 206 to the network node.

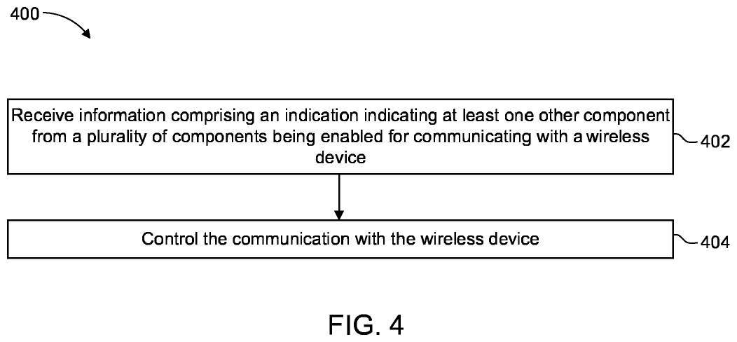

FIG. 4 is a flowchart illustrating example method steps of a method 400 performed by a network node for handling communication with the wireless device. The wireless device is connected to the industrial device in the industrial environment and the wireless device is in communication with the network nodes through at least one component of a communication circuitry. The communication circuitry comprising a plurality of components interconnected for communicating with the network node.

At step 402, the method 400 comprises receiving, from the wireless device, information comprising an indication indicating at least one other component from the plurality of components being enabled for communicating with the wireless device. For example, the indication indicates that the at least one component causing the failure event has been switched to at least one other component and the communication between the wireless device and the network node is continued through the at least another component.

At step 404, the method 400 comprises controlling the communication with the wireless device. For example the network node communicates with the wireless device through the at least one other component.

The network node receives information comprising one or more of a level of synchronicity between each component among the first set of components and parameters associated with the second set of components. For example, the network node receives information comprising the level of synchronicity between each BB processing component among the plurality of BB processing components when it is determined that the failure has been occurred in at least one BB processing component and the network node receives information comprising parameters associated with the RF components when it is determined that the failure has been occurred in at least one BB processing component. Further, the network node controls one or more control parameters related to the communication with the wireless device in accordance with the received information from wireless device. In an example, the network node resets the states of one or more control loops associated with the communication between the wireless device and the network node. In an example, the network node updates Hybrid Automatic Repeat Request, HARQ process status and the power control loop associated with the communication between the wireless device and the network node. In an example, the network node controls one or more control parameters comprises information related to one or more of channel between the wireless device and the network node, interference in the channel, beamforming measurements, rank and precoding for Multiple-Input Multiple-Output, MIMO, and/or multiple transmission and reception points, Multi-TRP, operation, power control, and inner loop and outer loop link adaptation.

In some embodiments, the network node detects occurrence of a failure event at a first network node. For example, the communication between the wireless device and the network node may be interrupted due to the failure event caused in the first network node. The network node further determines at least one other network node, i.e., a second network node among the one or more network nodes. Further, the first network node transmits the at least context parameter to the second network node for handling the communication with the wireless device. The context parameter may comprises information related to a mapping of the RF component to the BB processing component. For example, the first network node may track the mapping of the RF component to the BB processing component when the communication is provided through the first network node. The first network node may transmits, to the at least second network node, the information related to the mapping of the RF component to the BB processing component through X2 interface.

Thus, in a failure event caused by one of the component from the first set of components or the second set of components, the wireless device identifies another component from same set of components of wireless device to handle the failure event. The wireless device enable the another component for the communication between the wireless device and the one or more network nodes. Therefore, the communication between the wireless device and the network node may not be interrupted due to failure caused by the component of the wireless device or the network node. Thereby, the embodiments herein provides an improved method for handling communication between the wireless device and the network nodes in the industrial environment.

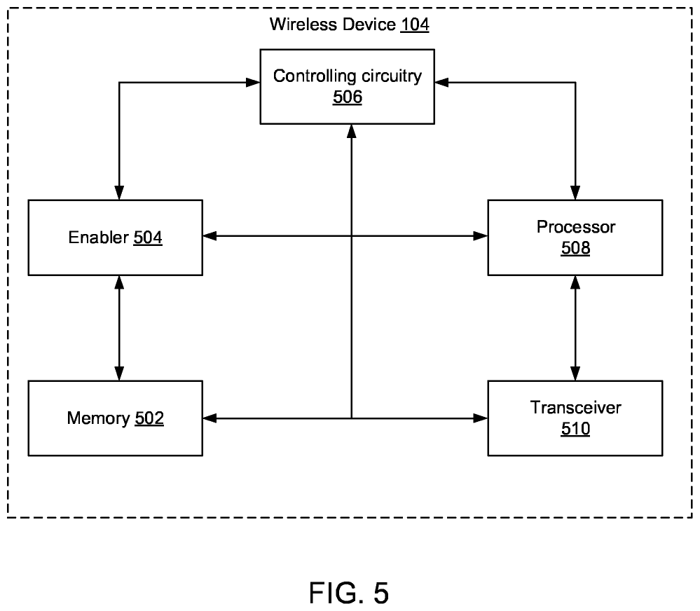

FIG. 5 is an example schematic diagram showing an apparatus 104. The apparatus 104 may e.g. be comprised in the wireless device. The apparatus 104 is capable of handling communication with the network node and may be configured to receive the signal from the industrial device and transmits the received signal to the network node 108 through the wireless communication network.

According to at least some embodiments of the present invention, the apparatus 104 in FIG. 5 comprises one or more modules. These modules may e.g. be a memory 502, an enabler 504, a controlling circuitry 506, a processor 508, and a transceiver 510. The controlling circuitry 506, may in some embodiments be adapted to control the above mentioned modules. The memory 502, the enabler 504, the processor 508, and the transceiver 510 as well as the controlling circuitry 506, may be operatively connected to each other.

The transceiver 510 may be adapted to receive a signal from the industrial device and transmit the signal to the network node in the wireless communication network. For example, the transceiver 510 may be adapted transmit, to the network node, an indication indicating that the at least another component has been enabled for the communication with the network node.

The controlling circuitry 506 may be adapted to detect occurrence of a failure event in the communication circuitry (as described above in conjunction with the method 300 and FIG. 3).

Further, the controlling circuitry 506 may be adapted to identify at least one component of the plurality of components causing the failure event. Further, the controlling circuitry 506 may be adapted to determine at least another component from the plurality of components, to handle the communication with the network node.

The processor 508 is adapted to perform the method 300 and FIG. 3 in conjunction with the controlling circuitry 506.

The enabler 504 is adapted to enable the at least one other component for the communication with the network node.

The memory 502 is coupled to the processor 508 and adapted to store one or more programs that perform the steps, services and functions disclosed herein when executed by the processor 508.

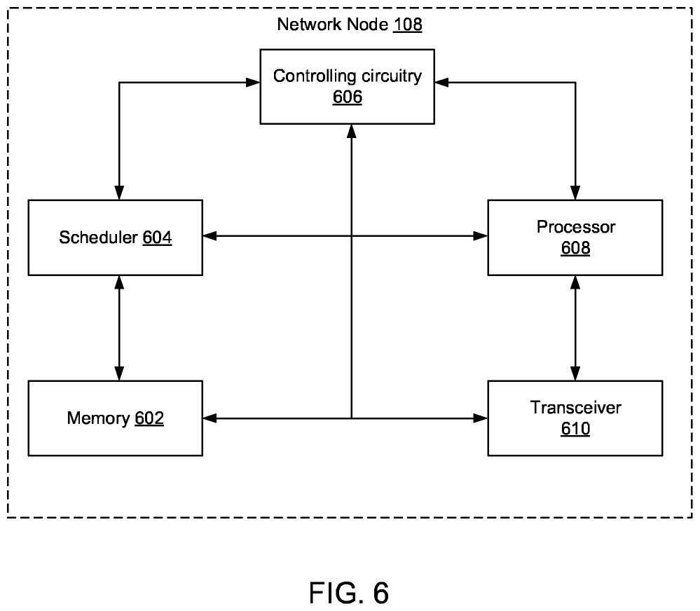

FIG. 6 is an example schematic diagram showing an apparatus 108. The apparatus 108 may e.g. be comprised in the network node. The apparatus 108 is capable of handling a communication with the wireless device and may be adapted to transmit the control signal to the wireless device and receive the signals from the wireless device.

According to at least some embodiments of the present invention, the apparatus 108 in FIG. 6 comprises one or more modules. These modules may e.g. be a memory 602, a scheduler 604, a controlling circuitry 606, a processor 608, and a transceiver 610. The controlling circuitry 606, may in some embodiments be adapted to control the above mentioned modules. The memory 602, the scheduler 604, the processor 608, and the transceiver 610 as well as the controlling circuitry 606, may be operatively connected to each other. The transceiver 610 may be adapted to receive a signal from the wireless device and transmit the control signal to wireless device in the wireless communication network. The transceiver 610 may be adapted to receive the indication indicating at least one other component from the plurality of components being enabled for communicating with the wireless device.

The controlling circuitry 606 may be adapted to control the communication with the wireless device (as described above in conjunction with the method 400 and FIG. 4).

Further, the processor 608 is adapted to perform the method 400 and FIG. 4 in conjunction with the controlling circuitry 606.

The scheduler 604 is adapted to schedule the radio resources for the communication with the wireless device.

Furthermore, the memory 602 is coupled to the processor 608 and adapted to store one or more programs that perform the steps, services and functions disclosed herein when executed by the processor 608.

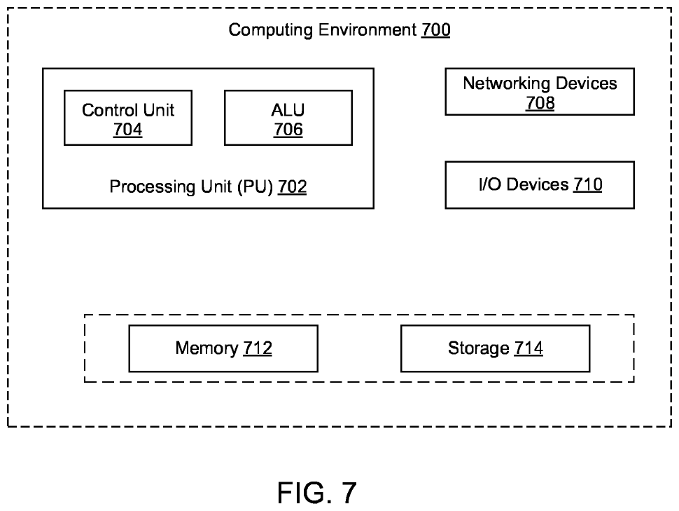

FIG. 7 illustrates an example computing environment 700 implementing a method and the network node and the wireless device as described in FIGS. 3 and 4. As depicted in FIG. 7, the computing environment 700 comprises at least one processing unit 702 that is equipped with a control unit 704 and an Arithmetic Logic Unit (ALU) 706, a plurality of networking devices 708 and a plurality Input output, I/O devices 710, a memory 712, and a storage 714. The processing unit 702 may be responsible for implementing the method described in FIGS. 3 and 4. For example, the processing unit 702 may in some embodiments be equivalent to the processor of the network node and the wireless device described above in conjunction with the FIGS. 3 and 4. The processing unit 702 is capable of executing software instructions stored in memory 712. The processing unit 702 receives commands from the control unit 704 in order to perform its processing. Further, any logical and arithmetic operations involved in the execution of the instructions are computed with the help of the ALU 706.

The computer program is loadable into the processing unit 702, which may, for example, be comprised in an electronic apparatus (such as a wireless device or a network node). When loaded into the processing unit 702, the computer program may be stored in the memory 712 associated with or comprised in the processing unit 702. According to some embodiments, the computer program may, when loaded into and run by the processing unit 702, perform execution of method steps according to, for example, any of the methods illustrated in FIGS. 3 and 4 or otherwise described herein.

The overall computing environment 700 may be composed of multiple homogeneous and/or heterogeneous cores, multiple CPUs of different kinds, special media and other accelerators. Further, the plurality of processing unit 702 may be located on a single chip or over multiple chips.

The algorithm comprising of instructions and codes required for the implementation are stored in either the memory 712 or the storage 714 or both. At the time of execution, the instructions may be fetched from the corresponding memory 712 and/or storage 714, and executed by the processing unit 702.

In case of any hardware implementations various networking devices 708 or external I/O devices 710 may be connected to the computing environment to support the implementation through the networking devices 708 and the I/O devices 710.

The embodiments disclosed herein can be implemented through at least one software program running on at least one hardware device and performing network management functions to control the elements. The elements shown in FIG. 7 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

1. A method performed by a wireless device for handling communication with a network node, the wireless device being connected to an industrial device in an industrial environment and the wireless device being in communication with the network node using a communication circuitry, said communication circuitry comprising a plurality of components interconnected for communicating with the network node, the method comprising:
detecting occurrence of a failure event in the communication circuitry;
identifying at least one component of the plurality of components causing the failure event;
determining at least another component from the plurality of components, to handle the communication with the network node; and
enabling the at least another component for the communication with the network node.

2. The method according to claim 1, wherein the plurality of components comprises a first set of components and a second set of components.

3. The method according to claim 2, wherein the first set of components comprises baseband (BB) processing components.

4. The method according to claim 2, wherein the second set of components comprises radio frequency (RF) components.

5. The method according to claim 2, wherein the step of determining at least another component from the plurality of components, to handle the communication with the network node comprising:
identifying whether the failure has been occurred in any component from the first set of components or the second set of components;
when it is identified that the failure has been occurred in any of the components in the first set of components, selecting at least another component from the first set of components; and
when it is identified that the failure has been occurred in any of the components in the second set of components, selecting at least another component from the second set of components.

6. The method according to claim 2, further comprising transmitting information to the network node when the failure has been occurred in any component in the plurality of components, the information comprising one or more of:
an indication to indicate the failure in any of components in the first set of components or the second set of components;
a level of synchronicity among the first set of components;
parameters associated with the second set of components; and
an indication to indicate that the at least another component has been enabled for the communication with the network node.

7. The method according to claim 6, wherein the parameters associated with the second set of components comprises one or more of:
information related to one or more antennas;
position information of the one or more antennas; and
delay information associated with feeders of the one or more antennas.

8. A method performed by a network node for handling communication with a wireless device, the wireless device being connected to an industrial device in an industrial environment and the network node being in communication with the wireless device through at least one component of a communication circuitry, said communication circuitry comprising a plurality of components interconnected for communicating with the network node, the method comprising:
receiving, from the wireless device, information comprising an indication indicating at least another component from the plurality of components being enabled for communicating with the wireless device; and
controlling the communication with the wireless device in accordance with the information indicating at least one other component enabled for communicating with the wireless device.

9. The method according to claim 8, wherein the information further comprises one or more of:
a level of synchronicity between each component among a first set of components of the plurality of components; and
parameters associated with a second set of components of the plurality of components.

10. The method according to claim 9, wherein the parameters associated with the second set of components comprise one or more of:
information related to one or more antennas;
position information of the one or more antennas; and
delay information associated with feeders of the one or more antennas.

11. The method according to claim 8, wherein the step of controlling the communication with the wireless device comprises:
controlling one or more control parameters related to the communication with the wireless device in accordance with the received information from the wireless device.

12. The method according to claim 11, wherein the one or more control parameters comprises information related to one or more of:
states of one or more control loops associated with the communication;
status of Hybrid Automatic Repeat Request (HARQ), process;
channel between the wireless device and the network node;
interference in the channel;
beamforming measurements;
rank and precoding for Multiple-Input Multiple-Output (MIMO), and/or multiple transmission and reception points (Multi-TRP) operation;
power control; and
inner loop and outer loop link adaptation.

13. The method according to claim 8, wherein the step of controlling the communication with the wireless device further comprises:
detecting occurrence of a failure event at the network node;
determining another network node for handling the communication with the wireless device; and
transmitting at least one context parameter to another network node for handling the communication with the wireless device.

14. The method according to claim 9, wherein the first set of components comprises a plurality of baseband (BB) processing components and the second set of components comprises a plurality of radio frequency (RF) components.

15. An apparatus of a wireless device for handling communication with a network node, the wireless device being connected to an industrial device in an industrial environment and the wireless device being in communication with the network node using a communication circuitry, said communication circuitry comprising a plurality of components interconnected for communicating with the network node, the apparatus comprising controlling circuitry configured to cause:
detection of occurrence of a failure event in the communication circuitry;
identification of at least one component of the plurality of components causing the failure event;
determination of at least another component from the plurality of components, to handle the communication with the network node; and
enabling of the at least another component for the communication with the network node.

16. The apparatus according to claim 15, wherein the plurality of components comprises a first set of components and a second set of components.

17. The apparatus according to claim 16, wherein the first set components comprises baseband (BB) processing components.

18. The apparatus according to claim 16, wherein the second set of components comprises radio frequency (RF) components.

19. The apparatus according to claim 16, wherein the controlling circuitry is configured to cause the step of determining at least another component from the plurality of components, to handle the communication with the network node by causing:
identification of whether the failure has been occurred in any component from the first set of components or the second set of components;
when it is identified that the failure has been occurred in any of the components in the first set of components, selection of at least another component from the first set of components; and
when it is identified that the failure has been occurred in any of the components in the second set of components, selection of at least another component from the second set of components.

20. The apparatus according to claim 16, wherein the controlling circuitry is further configured to cause transmission of information to the network node when the failure has been occurred in any component in the plurality of components, the information comprising one or more of:
an indication to indicate the failure in any of components in the first set of components or the second set of components;
a level of synchronicity among the first set of components;
parameters associated with the second set of components; and
an indication to indicate that the at least another component has been enabled for the communication with the network node.

21-31. (canceled)
